(19) United States
(12) Patent Application Publication
(10) Pub. No.: US 2006/0233476 A1
(43) Pub. Date: Oct. 19, 2006

(54) Ball bearing

(76) Inventors: Oswald Bayer, Aidhausen (DE); Otmar Hartling, Schonungen (DE)

Correspondence Address: LUCAS & MERCANTI, LLP, 475 PARK AVENUE SOUTH, 15TH FLOOR, NEW YORK, NY, 10016, US

(21) Appl. No.: 10/573,390

(22) PCT Filed: Sep. 17, 2004
(86) PCT No.: PCT/DE04/02083

§ 371 Date: Apr. 4, 2006

(30) Foreign Application Priority Data
Sep. 23, 2003 (DE) 103 43 881.5

(51) Int. Cl. F16C 19/00

(52) U.S. Cl. 384/470

(57) ABSTRACT

The invention relates to a ball bearing (1) provided with a bearing ring (3,4) and a cage (5, 35), in addition to at least one run-on surface (15) which is mounted on the bearing ring (3,4). The cage (5, 35) is provided with pockets (9, 41) which are adjacent to each other and which are arranged on the side of the periphery around the rotational axis (1a, 35a) of the ball bearing (1). Each pocket (9, 41) is defined in a demodulated axial first direction of the first edge (11, 36) by means of the axis of rotation (1a, 35a), in addition to being at least partially defined in at least one second direction of the second edge (12, 37) which is counter to the first direction, and at least one of the edges (11, 12, 36, 37) is defined in a radial direction by a radial guide surface (14, 45), whereby the guide surface (14,45) lies opposite the run-on surface (15) in at least a radially defined manner.

### FIELD OF THE INVENTION

The invention relates to a ball bearing with a bearing ring and with a cage and also with at least one run-on surface on the bearing ring, the cage being provided with pockets which are adjacent one another peripherally about an axis of rotation of the ball bearing and each of the pockets thereby being at least partly delimited in an axial first direction, in the same direction as the axis of rotation, by a first flange and in at least one second direction, counter to the first direction, by a second flange, and at least one of the flanges being delimited in a radial direction by a radial guiding surface and the guiding surface thereby lying at least radially opposite the run-on surface.

### BACKGROUND OF THE INVENTION

The invention relates to all conceivable designs of ball bearings in which the balls are guided in a cage and in which the flanges of the cage are radially offset in relation to one another. The invention also relates in particular to angular-contact ball bearings with symmetrical and/or unsymmetrical inner and outer rings. Furthermore, the invention can be used with preference for high-precision bearings, in particular whenever the cage is guided on the shoulder of the inner or outer ring that is low with respect to the raceway.

Ball bearings of this type designed as angular-contact ball bearings are often used for mounting spindles rotating at very high speeds. The mounting of the spindles has to meet very high requirements with regard to smooth running, heating in the points of support and with regard to the service life. Very smooth running of the bearings is also achieved for example by precise guidance of the cage in the bearing, since the position and movement of the cage must be stabilized in the operating state.

Up to the time of the invention, the guidance of the cage constantly presented problems to those skilled in the art. On account of different masses of the flanges between the cage and the guidance on the bearing ring, the cage tends to tilt within the guiding play about peripherally tangential tilting axes. The tilting of the cage also leads to edge contacts of the cage with the guidance on the bearing ring—the lubricating film between the cage and its guidance is entirely or partially broken. This in turn leads to increased wear and higher temperatures in the bearings and to their premature failure.

In U.S. Pat. No. 3,65,592, a ball bearing of the generic type is described. The angular-contact ball bearing has an outer bearing ring. The bearing ring is provided with the high shoulder that is common on bearings of this type. Also formed on the bearing ring is a run-on surface, which, as also in the other known prior art, may be formed on a low shoulder of the outer bearing ring. Running against the run-on shoulder is a ball cage. The cage is provided with pockets adjacent one another peripherally about an axis of rotation of the ball bearing. The pockets are respectively delimited by a flange in both axial directions, in the same direction as the axis of rotation. The flanges of the bearing of the generic type run annularly around the axis of rotation of the bearing or one flange is alternatively interrupted by snap-fit openings at the pockets, or the flanges are provided with other clearances between the pockets in the peripheral direction. Alternatively, the flanges are also reinforced between the pockets by the webs of the cage.

One of the flanges on the bearing described in U.S. Pat. No. 3,645,592 is delimited in a radial direction by an outer radial guiding surface and is radially guided in the bearing free from play with respect to the outer bearing ring on a run-on surface lying radially opposite the guiding surface. Such contact between the bearing ring and the cage disadvantageously creates high friction and wear. The cellular material of this cage is indeed conducive to the feeding of the lubricant to the guiding surface, but also disadvantageously weakens the strength of the cage. In a bearing rotating at very high speeds, a cage of this type cannot be used, or only under certain circumstances.

### SUMMARY OF THE INVENTION

The object of the invention is therefore to provide a ball bearing in which the unit comprising the bearing ring and the cage runs smoothly, in particular at high rotational speeds, in which the guidance of the cage on the bearing ring is adequately lubricated and in which the cage runs on the guide with little friction.

This object is achieved by the characterizing part of claim 1 and a further independent claim and also by the refinements thereof.

The invention is preferably suitable for guiding the cage on an outer bearing ring, enclosing the cage with the balls, but also for guiding on the inner bearing ring. In this case, the run-on surface is formed on the low shoulder or directly on a bearing ring without a low shoulder. The low shoulder is set back from the high shoulder radially with respect to the bearing ring. Alternatively, the run-on surface is formed directly on a bearing ring without a low shoulder. The invention is suitable in particular for angular-contact ball bearings of a high-precision design for the mounting of spindles. The contact angle of these bearings preferably lies in a range from 12°≦ to ≦35°.

The run-on surface is not aligned parallel to the axis of rotation in the axial direction (in an imaginary longitudinal section viewed along the axis of rotation), but instead runs at an angle to the axis of rotation. In the peripheral direction, the run-on surface is annularly formed or is divided in the peripheral direction into surface portions or is divided up into a number of run-on surfaces. Similarly, the guiding surface formed on the flange of the cage is annularly formed or interrupted in the peripheral direction or divided in the axial and/or peripheral direction into a number of guiding surfaces.

During operation, the guiding surface runs against the obliquely directed run-on surface. An axial force on the cage is thereby deliberately produced, preventing the cage from tilting about the tilting axes. The cage runs more smoothly in the rotating bearing.

The guiding surface on the cage may also remain aligned parallel to the axis of rotation or, as an alternative to this, also be inclined in relation to the axis of rotation and correspond to the path followed by the run-on surface with an at least approximately equal distance from the run-on surface. In the case of the last-mentioned configuration of the invention, when there is direct contact with the run-on during operation of the bearing, the distance is equal to zero or preferably determined by a defined gap size of a dimension formed uniformly between the surfaces. In the gap determined by the gap size between the run-on surface and the guiding surface, a hydrodynamic lubricating film can form, advantageously reducing the friction and the wear on the cage guide to virtually zero.

The invention also provides that, in all operating conditions, even under the most adverse operating conditions of the bearing, a smallest possible radial gap size greater than zero remains between the guiding surface and the run-on surface. This gap size also makes allowance for the fact that the cage may increase in diameter as a result of centrifugal forces, that there may be a radial offset between the center axis of the cage and the axis of rotation of the bearing and that the diameters of the cage may change on account of changes in volume by liquids, such as water or oils.

### BRIEF DESCRIPTION OF THE DRAWINGS

Further configurations of the invention and exemplary embodiments of the invention are explained in more detail below on the basis of FIGS. 1 to 3, in which specifically:

FIG. 1 shows an exemplary embodiment of a ball bearing in the embodiment of an angular-contact ball bearing for the mounting of spindles in longitudinal section along the axis of rotation of the ball bearing,

FIG. 2 shows a simplified representation, not to scale and enlarged, of the detail Z from FIG. 1,

FIG. 2a and FIG. 2b show further alternative configurations of the detail Z from FIG. 2,

FIG. 3 shows an exemplary embodiment of a cage in a sectioned detail for a bearing according to the invention made of plastic and

FIG. 3a shows the detail Z of the guiding surface from FIG. 3 with radial, spaced-apart depressions, in a sectional representation that is enlarged and not to scale.

### DETAILED DESCRIPTION OF THE DRAWINGS

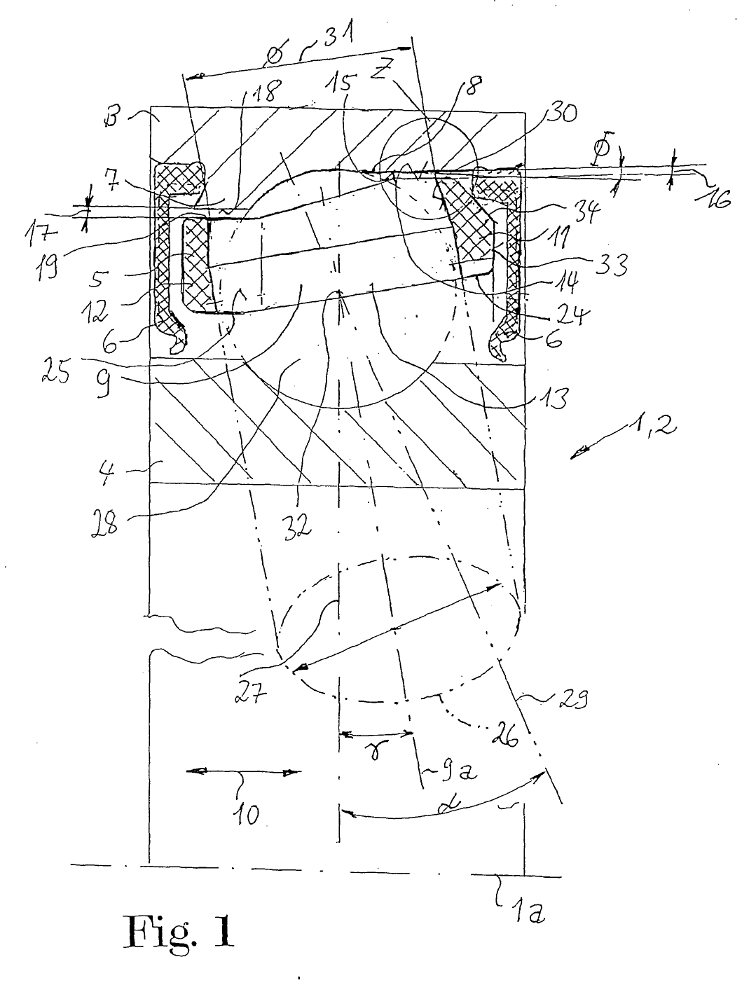

FIG. 1 shows an exemplary embodiment of a ball bearing 1 in the embodiment of an angular-contact ball bearing 2 for the mounting of spindles in longitudinal section along the axis of rotation 1a of the ball bearing. The ball bearing 1 has an outer bearing ring 3, an inner bearing ring 4 and a cage 5 and is provided with seals 6. Shoulders 7 and 8 are formed on the outer bearing ring 3. The high shoulder 7 rises up further radially in the direction of the axis of rotation la with respect to the bearing ring 3 than the low shoulder 8.

The cage 5 is peripherally provided with pockets 9 adjacent one another about the axis of rotation 1a of the ball bearing 1, of which only one pocket 9 is illustrated in the representation shown in FIG. 1 and is depicted there in longitudinal section. Each of the pockets 9 is delimited in one of the axial directions identified by the double-headed arrow 10 by a first flange 11 and in the direction counter to the first direction by a second flange 12. Webs 13 run between the pockets 9.

The flange 11 is delimited radially on the outside by a guiding surface 14. The guiding surface 14 lies radially opposite a run-on surface 15 on the shoulder 8. In this case, the guiding surface 14 is facing radially outward and the run-on surface 15 is facing radially inward. The run-on surface 15 and the guiding surface 14 run about the axis of rotation 1a and about the center axis of the cage 5, respectively. The guiding surface 14 and the run-on surface 15 are radially separated from each other by the gap 16. The gap 16 is greater than the gap distance 17 between a radial annular surface 18 of the shoulder 7 and the radially outer contour 19 of the flange 12.

The flanges 11 and 12 are offset radially in relation to each other in such a way that the contour 24 of the guiding surface 14 that lies radially closest to the axis of rotation 1a is radially further away from the axis of rotation 1a than the radially outermost contour 19 of the flange 12 furthest away from the axis of rotation.

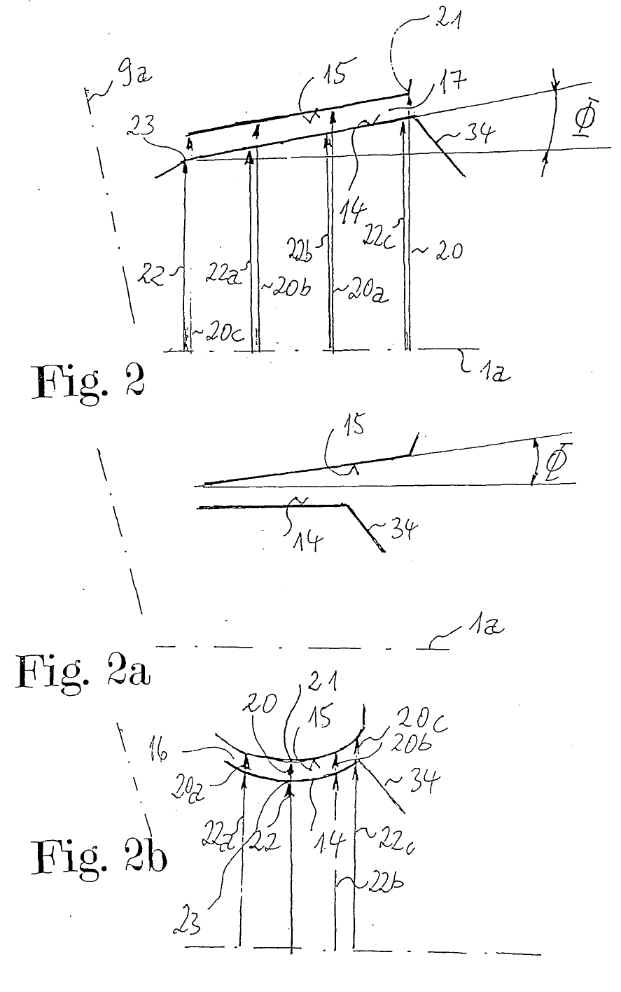

As can be seen from FIG. 2, a simplified, not to scale and enlarged representation of the detail Z from FIG. 1, both the guiding surface 14 and the run-on surface 15 are inclined in relation to the axis of rotation by the angle φ. Starting from a contour line 21 of the run-on surface 15 that is radially furthest away from the axis of rotation 1a and extends in the peripheral direction, the radial distances 20a-c between the axis of rotation 1a and the run-on surface 15 become increasingly smaller toward the center of the pocket 9a as they become increasingly axially distant from the contour line 21 and increasingly axially remote from the greatest distance 20. The guiding surface 14 is described by the distances 22a-c. The distances 22a-c become greater as they becoming increasingly axially remote from the contour line 23 and from the smallest distance 22 by the amount by which the distances 20a-c become smaller. Accordingly, gap 16 is defined by a uniform gap size.

FIG. 2a shows an alternative configuration of the detail Z relating to FIG. 2. The run-on surface 15 is in this case once again inclined by the angle φ, but the guiding surface 14 runs in the axial direction inclined parallel to the axis of rotation 1a.

FIG. 2b shows a further alternative configuration of the detail Z relating to FIG. 2. The radial distances 20a-c between the axis of rotation 1a and the run-on surface 15 that define the path of the run-on surface 15 become smaller in both axial directions as they become increasingly axially remote from the distance 20, so that the run-on surface 15 is convexly curved in relation to the axis of rotation in an imaginary longitudinal section viewed along the axis of rotation. The radially opposite guiding surface 14 is adapted to the run-on surface, curved concavely in the direction of the axis of rotation 1a. The surfaces 14 and 15 accordingly correspond to each other in such a way that the gap 16 is defined by a uniform gap size.

To simplify the representation, only the distances 20a-c and the distances 22a-c have been marked in the drawing, but it is evident that the run-on surface 14 and the guiding surface 15 can be described by any number of axially successive distances 20ₐ₋ₓ and distances 22ₐ₋ₓ, respectively.

The inner surface of the sub-portion 25 delimiting the pocket (9) is an inner surface portion of an imaginary hollow cylinder 26 running around annularly in the pocket. The pocket angle γ is smaller than the contact angle α. The pocket angle is the angle which is formed between the center axis 9a (corresponds to the center of the pocket 9a of the hollow cylinder 26) and between an imaginary line 27 running through the pocket (9) and perpendicular to the axis of rotation 1a. The contact angle α is the contact angle of the angular-contact ball bearing and is formed between a contact line 29, intersecting the ball 28 in the pocket 5 centrally at the center 32 of the ball 28, and the perpendicular line 27. Each individual ball 28 is held radially outwardly in its respective pocket 5. The shaping of the pocket provides for this purpose that the surface portion 25 goes over into a sub-portion 30, which is defined by the inner lateral surface of a hollow truncated cone. The free distance describing the lateral surface is in this case an inside diameter 31 and is less than the diameter of the ball 28 in the pocket 5 and is also at a greater distance away from the axis of rotation la than the center 32 of the ball 5.

The cage 5 is set back in respect of the flange 11 on its end face 33, facing away from the pocket 9 and axially terminating the cage 5, axially in the direction of the pocket 9 and, with respect to the guiding surface 14, radially in the direction of the axis of rotation 1a. As a result, the cage has a bevel 34, running around the axis of rotation 1a, between the guiding surface and the end face, by which a clearance for the seat of the seal 6 is created.

At least the inner contour of the cage 5, but also possibly the bevel 34, are produced by means of machining processes. For instance, it is conceivable for the inner contour of the pocket 90 to be produced by drilling, the center axis of a drill corresponding to the center axis 9a.

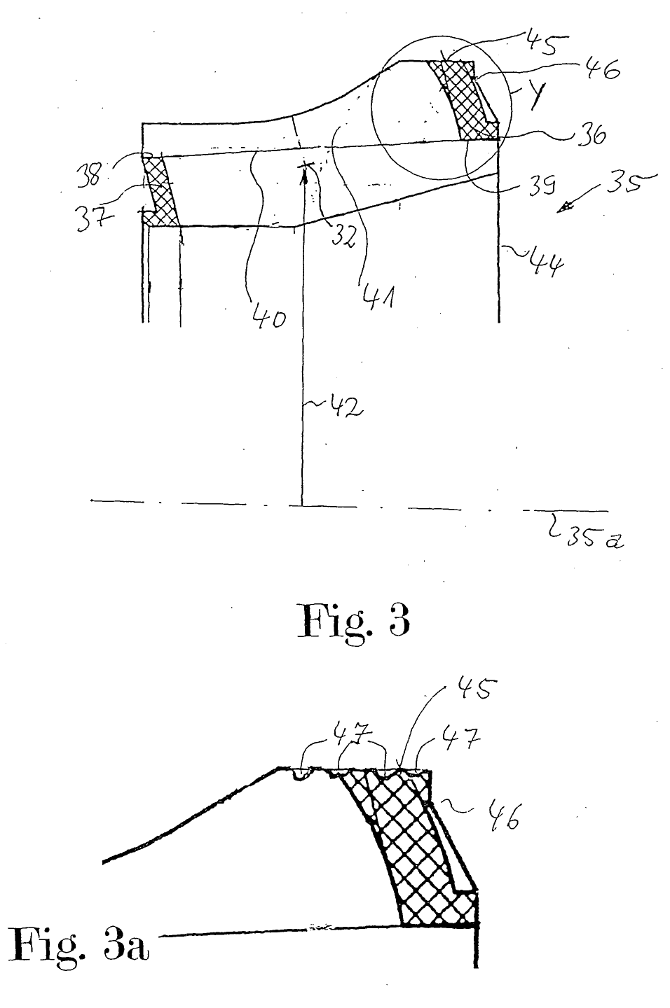

Alternatively, the invention is also suitable for use in bearings of which the plastic cages are produced in injection molds. For instance, FIG. 3 shows an exemplary embodiment of a cage 35 made of plastic in a sectioned representation of a detail for a bearing according to the invention. The first flange 36 of the cage 35 is radially offset in relation to the second flange 37 to such an extent that the radially outermost outer contour 38 of the second flange 37, radially furthest away from the axis of rotation 35a, and a radially innermost inner contour 39 of the first flange 36, lying closest to the axis of rotation 35a, abut a common imaginary parting plane 40. In this case, the inner contour 39 in the direction of the axis of rotation 35a terminates radially with the parting plane 40 and the outer contour 38 away from the axis of rotation 35a terminates radially with the parting plane 40.

The parting plane 40 is a parting plane in an injection mold (not represented) and extends from the first flange 36 to the second flange 37. The pocket 41 is radially divided by the parting plane 40. The parting plane 40 is kept radially at a distance from a pitch radius 42. The pitch radius 42 describes the common pitch circle taken through the centers 32 of a row of balls of the annular-contact ball bearing (not represented any further).

The cage 35 is set back in respect of the flange 43 on its end face 44, facing away from the pocket 41 and axially terminating the cage 35, axially in the direction of the pocket 41 and, with respect to the guiding surface 45, radially in the direction of the axis of rotation 35a in such a way that the cage 35 has a channel 46, running around the axis of rotation 35a, between the guiding surface 45 and the end face 44.

The guiding surface 45 has peripherally, distributed in random arrangement over this surface, depressions 47 (FIG. 3a), the depth of which is formed in the order of magnitude of a few tenths of a millimeter (formation similar to the surface of an orange peel). Also conceivable are depressions of this type in the form of channels (preferably running around in the peripheral direction) or pockets with defined dimensions of the order of magnitude of a few tenths of a millimeter to over one millimeter and with fixed distances from one another. The depressions are intended as accumulators for a lubricant such as grease or oil and reduce the friction between the guiding surface 45 and an opposite run-on surface during the operation of the bearing.

### LIST OF DESIGNATIONS

1 ball bearing
1a axis of rotation
2 angular-contact ball bearing
3 outer bearing ring
4 inner bearing ring
5 cage
6 seal
7 shoulder
8 shoulder
9 pocket
9a center of pocket (center axis)
10 double-headed arrow
11 flange
12 flange
13 web
14 guiding surface
15 run-on surface
16 gap
17 gap distance
18 annular surface
19 contour
20a-c distance
21 contour line
22a-c distance
23 contour line
24 contour
25 sub-portion
26 hollow cylinder
27 line
28 ball
29 contact line
30 sub-portion
31 inside diameter
32 center
33 end face
34 bevel
35 cage
35a axis of rotation
36 flange
37 flange
38 outer contour
39 inner contour
40 parting plane
41 pocket
42 parting radius
43 flange
44 end face
45 guiding surface
46 channel
47 depression

1. A ball bearing (1) with a bearing ring (3, 4) and with a cage (5, 35) and also with at least one run-on surface (15) on the bearing ring (3, 4), the cage (5, 35) being provided with pockets (9, 41) which are adjacent one another peripherally about an axis of rotation (1a, 35a) of the ball bearing (1) and each of the pockets (9, 41) thereby being at least partly delimited in an axial first direction, in the same direction as the axis of rotation (1a, 35a), by a first flange (11, 36) and in at least one second direction, counter to the first direction, by a second flange (12, 37), and at least one of the flanges (11, 12, 36, 37) being delimited in a radial direction by a radial guiding surface (14, 45) and the guiding surface (14, 45) thereby lying at least radially opposite the run-on surface (15), characterized in that radial distances (20a, 20b, 20c) between the axis of rotation (1a, 35a) and the run-on surface (15) that define the path of the run-on surface (15) become smaller as they become increasingly axially remote from a furthest distance (20) between the axis of rotation (1a, 35a) and the run-on surface (15), so that the run-on surface (15) slopes down in relation to the axis of rotation (1a, 35a) in an imaginary longitudinal section viewed along the axis of rotation (1a, 35a).

2. The ball bearing as claimed in claim 1, characterized in that the distances (20a, 20b, 20c) between the axis of rotation (1a) and the run-on surface (15) become smaller as they become increasingly axially remote from a center of the pocket (9a).

3. The ball bearing as claimed in claim 1, characterized in that the distances (20a, 20b, 20c) between the axis of rotation (1a) and the run-on surface (15) become smaller as they become decreasingly axially remote from a center of the pocket (9a).

4. The ball bearing as claimed in claim 1, characterized in that the guiding surface (14) is aligned in the axial directions (10) parallel to the axis of rotation (1a).

5. The ball bearing as claimed in claim 1, characterized in that, starting from a smallest distance (22) of a contour line (21) of the guiding surface (14) that is radially closest to the axis of rotation 1a, the radial distances (22a, 22b, 22c) between the axis of rotation (1a) and the guiding surface (15) that describe the path of the guiding surface (14) become greater as they become increasingly axially remote from the smallest distance (22) by the amount by which the radial distances (20a, 20b, 20c) between the run-on surface (15) and the axis of rotation (1a) become smaller.

6. The ball bearing as claimed in claim 1, characterized in the guiding surface (14, 45) is facing radially outward and the run-on surface (15) is facing radially inward.

7. The ball bearing as claimed in claim 6, characterized in that the contour line (24) of the guiding surface (14) that lies radially closest to the axis of rotation (1a, 35a) is radially further away from the axis of rotation (1a, 35a) than a radially outermost contour (19) of the second flange (12) radially furthest away from the axis of rotation (1a, 35a).

8. The ball bearing as claimed in claim 7, characterized in that the ball bearing (1) is an angular-contact ball bearing (2), the bearing ring (3) enclosing the cage (5) and thereby having a first shoulder (8), with the annularly formed run-on surface (15), and also a second shoulder (7), the second shoulder (7) lying radially opposite the second flange (12).

9. The ball bearing as claimed in claim 8, characterized in that a smallest possible radial gap size between the guiding surface (14) and the run-on surface (15) is greater than zero, the smallest possible radial gap size being a smallest operating play between the rotating cage (5) in an operating state of the ball bearing (1).

10. The ball bearing as claimed in claim 9, characterized in that the gap size is formed in a size equal to or greater than four micrometers to equal to or greater than eight micrometers.

11. The ball bearing as claimed in claim 8, characterized in that the cage (5, 35) is made of plastic and in that the guiding surface (14, 45) has, at least in the peripheral direction of the cage (5, 35) radial, spaced-apart depressions (47).

12. The ball bearing as claimed in claim 8, characterized in that the cage (5, 35) is made of plastic and in that at least the second flange (12) has a sub-portion (25) of an inner surface of an imaginary hollow cylinder (26) that is directed into the pocket (9), and in that a pocket angle between the center axis (9a) of the hollow cylinder (26) and an imaginary line (27) perpendicular in this case to the axis of rotation (1a) is less than the contact angle between the line (27) and between a contact line (29) of the angular-contact ball bearing (2), the perpendicular line (27) and the contact line (29) intersecting the ball (28) at the center (32) and thereby the contact line (29) intersecting the axis of rotation (1a) at an acute angle.

13. The ball bearing as claimed in claim 12, characterized in that the sub-portion (25) of the inner surface delimiting the pocket (9) is an inner surface of the hollow cylinder (26) running around annularly in the pocket (9).

14. The ball bearing as claimed in claim 13, characterized in that a pocket angle between the center axis (9a) of the hollow cylinder (26) and an imaginary line (27) perpendicular in this case to the axis of rotation (1a) is less than the bearing contact angle between the line (27) and a contact line (29) of the angular-contact ball bearing (2), the perpendicular line (27) and the contact line (29) intersecting the ball (28) at the center (32) and thereby the contact line (29) intersecting the axis of rotation (1a) at an acute angle.

15. The ball bearing as claimed in claim 8, characterized in that at least a free distance (31) between two mutually opposite further sub-portions (30) of the pocket (9) is less than a smallest possible diameter of a ball (28) in the pocket (9), the free distance (31) being at a greater distance away from the axis of rotation (1a) than the center (32) of the ball (28).

16. The ball bearing as claimed in claim 15, characterized in that at least a sub-portion (25) of an inner surface delimiting the pocket (9) is a surface portion of a hollow cylinder (26) running around annularly in the pocket, the surface portion going over into a further sub-portion (30) of the inner surface and the further sub-portion (30) thereby having the inner lateral surface of an imaginary hollow truncated cone, and the inside diameter (31) describing the hollow truncated cone at the inwardly narrowest point being the free distance (31).

17. The ball bearing as claimed in claim 8, characterized in that the cage (35) is made of plastic and the first flange (36) is radially offset in relation to the second flange (37) to such an extent that the radially outermost contour 38 of the second flange (37), radially furthest away from the axis of rotation, and a radially innermost inner contour (39) of the first flange (36), lying closest to the axis of rotation, together abut an imaginary parting plane (40) in the direction of the axis of rotation (35a), the parting plane (40) radially dividing the pocket (41) from the first flange (36) to the second flange (37), and in that the parting plane (40) is kept radially at a distance from a pitch radius (42), the pitch radius (42) describing a common pitch circle of the angular-contact ball bearing (2) taken through the centers (32) of the balls (28) in the pockets (41).

18. The ball bearing as claimed in claim 8, characterized in that the cage (5, 35) is recessed at the first flange (11, 36), on a side (44) facing away from the pocket (9, 41) and axially terminating the cage (5, 35), axially in the direction of the pocket (9, 41) and, at the guiding surface (14, 45), radially in the direction of the axis of rotation (1a, 35a).

19. The ball bearing as claimed in claim 18, characterized in that the cage (5) has a bevel (34), running around the axis of rotation (1a), between the guiding surface (14) and the side (33).

20. The ball bearing as claimed in claim 18, characterized in that the cage (35) has a channel (46), running around the axis of rotation (35a), between the guiding surface (45) and the side (44).

21. An angular-contact ball bearing (2) with a bearing ring (3) and a cage (5) and also with at least one annularly formed run-on surface (15) on the bearing ring (3), the cage (5) being provided with pockets (9) which are adjacent one another peripherally about an axis of rotation (1a) of the cage (5) and each of the pockets (9) thereby being at least partly delimited in an axial first direction, in the same direction as the axis of rotation (1a), by a first flange (11) and in at least one second direction, counter to the first direction, by a second flange (12), and at least the first flange (11) being delimited in a radial direction by a radial guiding surface (14) and the guiding surface (14) thereby lying at least radially opposite the run-on surface (15) and the second flange (12) thereby lying at least radially opposite a shoulder (8) on the bearing ring (3), characterized in that a smallest possible radial gap size between the guiding surface (14) and the run-on surface (15) is greater than zero, the smallest possible radial gap size being a smallest operating play between the rotating cage (5) in an operating state of the angular-contact ball bearing (2), and in that the gap size is less than a smallest possible further radial gap size between the second flange (12) and the shoulder (8).

22. The ball bearing as claimed in claim 21, characterized in that the gap size is formed in a size equal to or greater than four micrometers to equal to or greater than eight micrometers.

23. The ball bearing as claimed in claim 21, characterized in that the cage (5) is made of plastic and in that the guiding surface (14) has, at least in the peripheral direction of the cage (5) radial, spaced-apart depressions (47).
